(19) United States
(12) Patent Application Publication
(10) Pub. No.: US 2014/0067582 A1
(43) Pub. Date: Mar. 6, 2014

(54) AUCTION BID INCENTIVES BASED ON TIME AS HIGHEST BIDDER

(71) Applicant: William Wolfram, Helsinki (FI)

(72) Inventor: William Wolfram, Helsinki (FI)

(73) Assignee: DealDash, Inc.

(21) Appl. No.: 13/601,656

(22) Filed: Aug. 31, 2012

(51) Int. Cl. G06Q 30/08

(52) U.S. Cl. 705/26.3

(57) ABSTRACT

Systems and methods for hosting an auction. The system and methods generally include an data processing system configured to receive a bid proposing a bid value from a bidder at a bid time. The system determines that the bid value exceeds a benchmark. The system notes that the bid value becomes a new benchmark and tracks a period of time during which the bid value is the benchmark. The system allots or allocates an incentive to the bidder based on the period of time. A bidder is rewarded for the time during which the bidder's bids are the best bid in the auction.

### BACKGROUND

Auctions generally feature a group of buyers bidding on an auction offer. The Auction offer may be an item, a service, an opportunity, or anything else that may be auctioned. Typically, an auctioneer announces a current bid price, e.g., a highest bid or an initial expected bid, and requests higher bids from prospective buyers. The prospective buyers, bidders, enter bids in an attempt to have the highest bid—although usually with the secondary goal of not over-bidding. An auction may proceed until no one is willing to place a higher bid or until some other threshold event such as the termination of a pre-set period of time. Auctions may be held in person or remotely, e.g., by telephone or Internet, and bids may be public or private, as in a secret auction.

An auction may be held entirely online, e.g., using a website accessible via the Internet. A seller may place an auction offer on the website and allow bidders to place bids on the offer. Online auctions are generally terminated at a preset end time, with the highest bidder at the end time winning the auction. It is a common tactic to wait until almost the end time to place a high bid.

### SUMMARY OF THE INVENTION

Aspects and embodiments of the present disclosure are directed to systems and methods of hosting an auction. In general, in some embodiments, an auction server receives a bid proposing a bid value from a bidder at a bid time. The auction server determines that the bid value exceeds a benchmark, that is, the bid value is now the best bid in the auction. The bid value become the benchmark and the auction server tracks a period of time during which the bid value is the benchmark. The auction server allots, or allocates, based on the period of time, an incentive to the bidder.

At least one aspect is directed to methods of receiving a first bid from a first bidder at a first time, wherein the bid proposes a first value and determining that the first value exceeds a benchmark. The method includes setting the benchmark equal to the first value, tracking a first period of time during which the first value remains equal to the benchmark, and allotting an incentive to the first bidder based on the first period of time. The method may be implemented by a computer. The method may be encoded as software instructions, which, when executed by computing hardware cause the computer to execute the method.

The methods may further include terminating the auction while the first value equals the benchmark, ending the first period of time, and charging the first bidder the first value. The methods may include receiving a second bid from a second bidder at a second time, wherein the second time is subsequent to the first time and the second bid proposes a second value exceeding the benchmark value, ending the first period of time, setting the benchmark equal to the second value, tracking a second period of time during which the second value remains equal to the benchmark, and allotting, based on the second period of time, an incentive to the second bidder. The methods may include receiving a second bid from a second bidder at a second time, wherein the second time is subsequent to the first time and the second bid proposes a second value exceeding the benchmark value, ending the first period of time, setting the benchmark equal to the second value, tracking a second period of time during which the second value remains equal to the benchmark, and allotting, based on the second period of time, an incentive to the second bidder. The methods may include receiving a second bid from a second bidder at a second time, wherein the second time is subsequent to the first time and the second bid proposes a second value exceeding the benchmark value, ending the first period of time and setting the benchmark equal to the second value responsive to receiving the second bid, receiving a third bid from the first bidder at a third time, wherein the third time is subsequent to the second time and the third bid proposes a third value exceeding the benchmark equal to the second time, ending the second period of time and setting the benchmark equal to the third value responsive to receiving the third bid, and allotting, based on the third period of time, an incentive to the first bidder in addition to the incentive allocated based on the first period of time.

The methods may further include accepting, as a bid, an incremental value over a previous bid such that the first value is the previous bid value plus the incremental value over the previous bid value. Allotting the incentive may be based on a quantity of time units, e.g., half seconds, in the first period of time wherein the first value is equal to the benchmark. The incentive may be a point for each unit of time (time units) in the quantity and one or more points are redeemable for one or more of a prize, a financial amount, a level increase, virtual credits, discounts, upgrades, additional bid opportunities, access to restricted auctions, VIP access, travel rewards, goods, and services. The benchmark may be a value higher than any other bid value in the auction, such that to exceed the benchmark a bid must be higher. The benchmark may be a value lower than any other bid value in the auction, such that to exceed the benchmark a bid must be lower. Tracking the first period of time may comprise periodically checking the benchmark. Tracking the first period of time may comprise computing an elapsed time from the first time to either of a time associated with a subsequent bid having a bid value higher than the first value and an auction terminating event.

At least one aspect is directed to systems comprising an auction server configured to receive a first bid from a first bidder at a first time, wherein the bid proposes a first value and determine that the first value exceeds a benchmark. The server is configured to set the benchmark equal to the first value, track a first period of time during which the first value remains equal to the benchmark, and allot an incentive to the first bidder based on the first period of time. In some systems, the server includes a physical computing device executing software instructions, which when executed, cause the physical computing device to do the same.

The auction server may be further configured to terminate the auction, while the first value equals the benchmark, end the first period of time, and charge the first bidder the first value. The auction server may be further configured to receive a second bid from a second bidder at a second time, wherein the second time is subsequent to the first time and the second bid proposes a second value exceeding the benchmark value, end the first period of time, set the benchmark equal to the second value, track a second period of time during which the second value remains equal to the benchmark, and allot, based on the second period of time, an incentive to the second bidder. The auction server may be further configured to receive a second bid from a second bidder at a second time, wherein the second time is subsequent to the first time and the second bid proposes a second value exceeding the benchmark value, end the first period of time, set the benchmark equal to the second value, track a second period of time during which the second value remains equal to the benchmark, and allot, based on the second period of time, an incentive to the second bidder. The auction server may be further configured to receive a second bid from a second bidder at a second time, wherein the second time is subsequent to the first time and the second bid proposes a second value exceeding the benchmark value, end the first period of time and set the benchmark equal to the second value responsive to receiving the second bid, receive a third bid from the first bidder at a third time, wherein the third time is subsequent to the second time and the third bid proposes a third value exceeding the benchmark equal to the second time, end the second period of time and set the benchmark equal to the third value responsive to receiving the third bid, and allot, based on the third period of time, an incentive to the first bidder in addition to the incentive allocated based on the first period of time.

The auction server may be further configured to accept, as a bid, an incremental value over a previous bid such that the first value is the previous bid value plus the incremental value over the previous bid value. The auction server may be further configured to allot the incentive based on a quantity of time units, e.g., half seconds, in the first period of time wherein the first value is equal to the benchmark. The incentive may be a point for each unit of time (time units) in the quantity and one or more points are redeemable for one or more of a prize, a financial amount, a level increase, virtual credits, discounts, upgrades, additional bid opportunities, access to restricted auctions, VIP access, travel rewards, goods, and services. The benchmark may be a value higher than any other bid value in the auction, such that to exceed the benchmark a bid must be higher. The benchmark may be a value lower than any other bid value in the auction, such that to exceed the benchmark a bid must be lower. The auction server may be further configured to track the first period of time by periodically checking the benchmark. The auction server may be further configured to track the first period of time by computing an elapsed time from the first time to either of a time associated with a subsequent bid having a bid value higher than the first value and an auction terminating event.

At least one aspect is directed to methods of incentivizing bidding at an online auction website, where each auction having at least one bidder has a highest bidder. The methods include awarding a first incentive to a first bidder in a first auction, the incentive based on a first period of time for which the first bidder is the highest bidder for the first auction and awarding a second incentive to the first bidder in a second auction, the incentive based on a second period of time for which the first bidder is the highest bidder for the second auction. The methods include awarding a third incentive to the first bidder based on a third period of time for which the first period of time and on the second period of time are concurrent. The methods may further include accumulating an incentive balance for the first bidder, adding the first incentive, the second incentive, and the third incentive to the incentive balance and displaying, via the auction website, an indicator of the incentive balance during either or both of the first period of time and the second period of time. The methods may be implemented by a computer. The methods may be encoded as software instructions, which, when executed by computing hardware cause the computer to execute the method. At least one aspect is directed to a system including an auction server configured to execute the methods.

At least one aspect is directed to non-transitory computer-readable storage media storing processor executable instructions, which, when executed by one or more processors, cause the one or more processors to execute one or more of the methods described.

These and other aspects and embodiments are discussed in detail below. The foregoing information and the following detailed description include illustrative examples of various aspects and embodiments, and provide an overview or framework for understanding the nature and character of the claimed aspects and embodiments. The drawings provide illustration and a further understanding of the various aspects and embodiments, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram illustrating an example environment for hosting an online auction;

FIG. 2 is a block diagram illustrating an example computer system that may be employed to implement various elements of the systems and methods described and illustrated herein, according to an illustrative embodiment;

FIG. 3 is a block diagram of an example system for hosting an auction;

FIG. 4 is a block diagram of a user interface to an online auction system;

FIG. 5 is a flow diagram illustrating a method of hosting an auction; and

FIG. 6 is a flow diagram illustrating a method of hosting an auction.

### DETAILED DESCRIPTION

Following below are more detailed descriptions of various concepts related to, and embodiments of, methods of, apparatuses for, and systems for hosting an auction. The various concepts introduced above and discussed in greater detail below may be implemented in any of numerous ways, as the described concepts are not limited to any particular manner of embodiment. Although this disclosure focuses on web sites as exemplary hosts of auctions, alternative auction hosts may make use of the novel features described herein without departing from the scope of the invention. Examples of specific embodiments and applications are provided primarily for illustrative purposes.

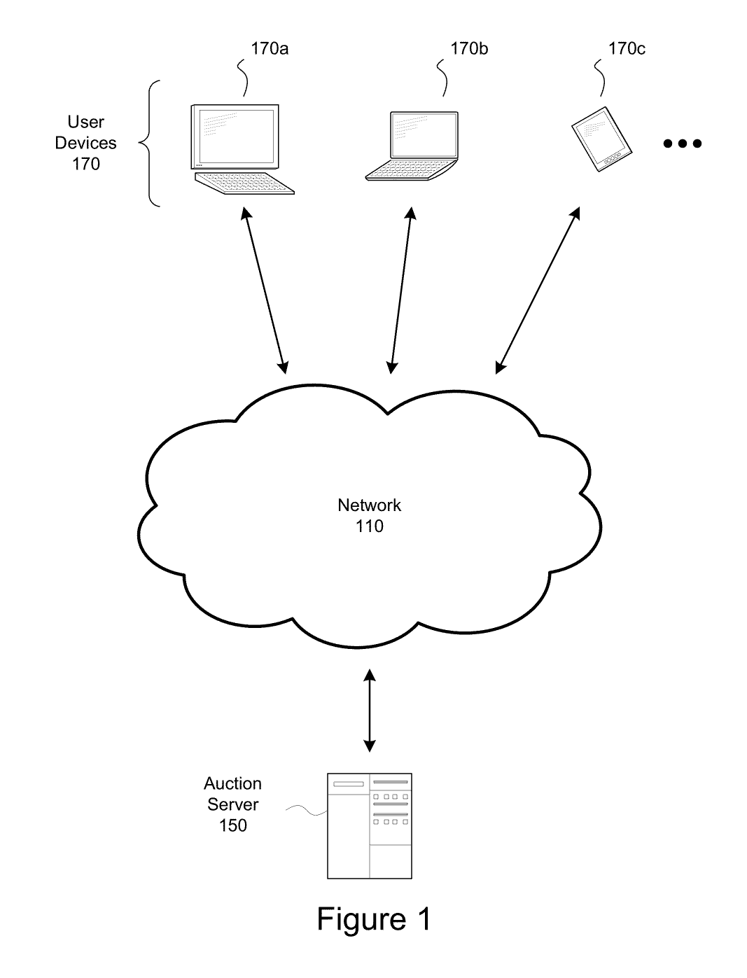

FIG. 1 illustrates an example environment for hosting an online auction according to an embodiment of the present disclosure. An auction server 150 is accessible to user devices 170 via a network 110, e.g., the Internet. The user devices 170 may be any device capable of accessing the auction server 150 via the network 110. For example, a user device may be a desktop computer 170a, a laptop computer 170b, or a mobile device 170c such as a smart phone, tablet, or digital pad.

The network 110 can be a local-area network (LAN), such as a company intranet, a metropolitan area network (MAN), or a wide area network (WAN), such as the Internet and the World Wide Web. The network 110 may be any type and/or form of network and may include any of a point-to-point network, a broadcast network, a wide area network, a local area network, a telecommunications network, a data communication network, a computer network, an asynchronous transfer mode (ATM) network, a synchronous optical network (SONET), a wireless network, an optical fiber network, and a wired network. In some embodiments, there are multiple networks 110 between participants, for example a smart phone 170c typically communicates with Internet servers via a wireless network connected to a private corporate network connected to the Internet. The network 110 may be public, private, or a combination of public and private networks. The topology of the network 110 may be a bus, star, ring, or any other network topology capable of the operations described herein. The network 110 can be used to access the auction server 150 by at least one user device 170, such as a laptop, desktop, tablet, electronic pad, personal digital assistant, smart phone, television, kiosk, or portable computer.

The auction server 150 is illustrated as a single server, but may be implemented as several distinct servers working cooperatively. The auction server 150 may include a web server hosting an online auction website and back-end server managing the data required for the website. The auction server 150 interacts with one or more user devices 170, enabling the users to create auctions, place bids on auctions, and maintain information related to auctions. In some embodiments, users establish an account with the auction website. The auction server 150 manages such accounts and enables users to maintain account data. In some embodiments, different accounts have different privileges. For example, some accounts may have a VIP status. In some embodiments, an account has an associated level, where higher levels allow the account holder or user to access additional features. For example, a VIP or high level account may allow the user to create or access restricted auctions, to collect additional awards, to collect awards at a faster pace, to earn credit, or to be eligible various discounts.

The user devices 170 may include any device capable of accessing the auction server 150 via the network 110. Example user devices 170 include a desktop computer 170a, a laptop or personal computer 170b, or a mobile device 170c, such as a tablet, an electronic pad, a personal digital assistant, or a smart phone. Other example user devices 170 include a kiosk, a television, or a gaming system. Generally, the user devices 170 include a display element, however this is not required. The user devices 170 present an interface for the auction server 150 to a user. For example, in some embodiments, the user accesses features of an auction using a web browser running on the user device.

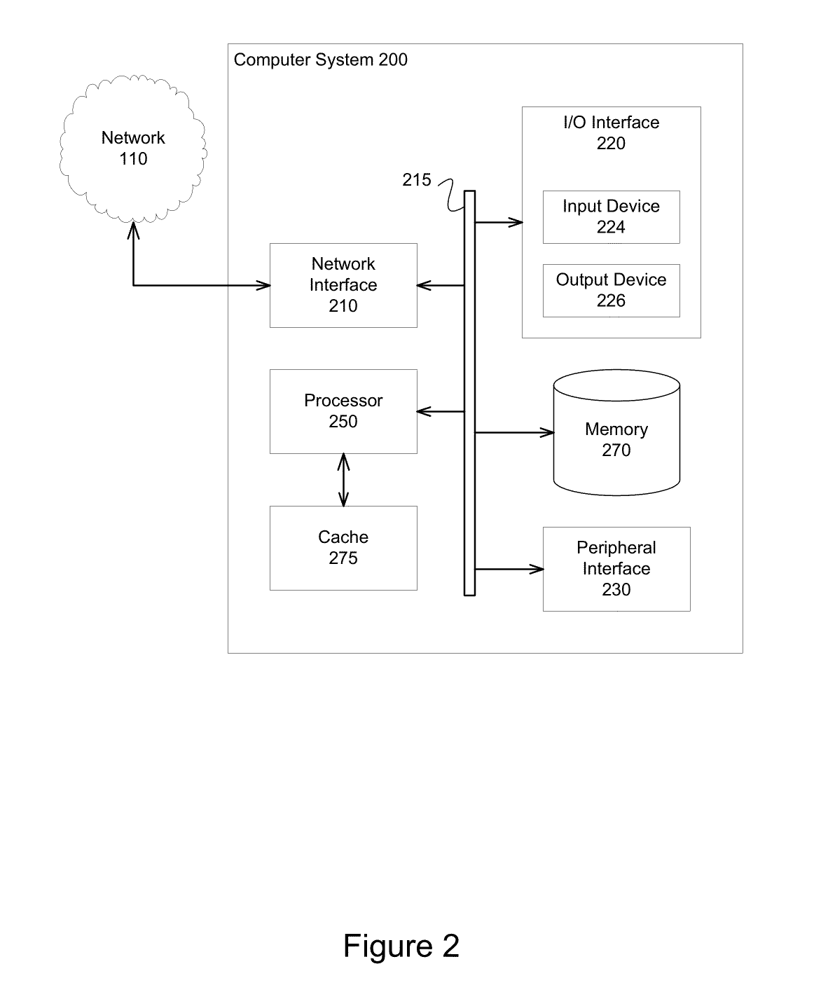

FIG. 2 illustrates an example computer system 200 suitable for use in implementing the computerized components of the system 100. The example computer system 200 includes one or more processors 250 in communication, via a bus 215, with one or more network interfaces 210 (in communication with the network 110), I/O interfaces 220 (for interacting with a user or administrator), and memory 270. The processor 250 incorporates, or is directly connected to, additional cache memory 275. In some uses, additional components are in communication with the computer system 200 via a peripheral interface 230. In some uses, such as in a server context, there is no I/O interface 220, or the I/O interface 220 is not used.

In some embodiments, the user devices 170 illustrated in FIG. 1 are constructed to be similar to the computer system 200 of FIG. 2. For example, a user interacts with an input device 224, e.g., a keyboard, mouse, or touch screen, to access an auction, e.g., via a web page, over the network 110. The interaction is received at the user's device's interface 210, and responses are output via output device 226, e.g., a display, screen, touch screen, or speakers. The output may be comprised of a mix of data received from the auction server 150 and from other systems.

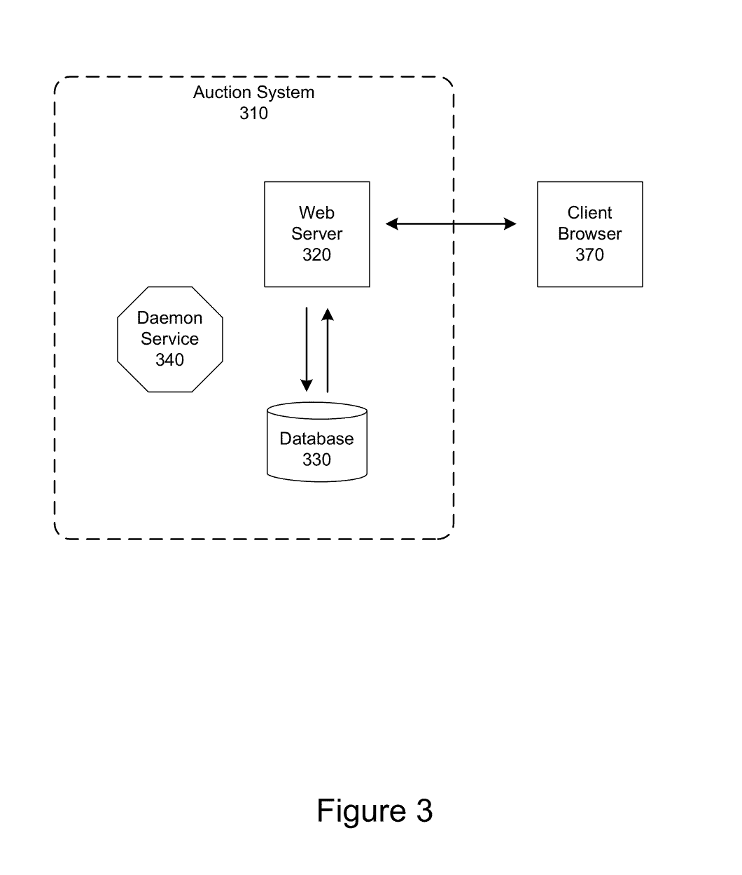

FIG. 3 illustrates example system for hosting an auction. The auction server 150 illustrated in FIG. 1 may comprise an auction system 310. The auction system 310 illustrated includes a web server 320, a database 330, and a daemon service 340. The web server 320 communicates with a client browser 370, e.g., over a network 110. The communication between the web server 320 and the client browser 370 may use the hypertext transport protocol (HTTP). In some embodiments, the communication includes AJAX calls. In some embodiments, the communication relies on Java, Javascript, Perl, Ruby, Ruby on Rails, or Flash. The auction system 310 may be unified or distributed.

The web server 320 is illustrated as a single server, but may be implemented as multiple servers working cooperatively. The web server may be implemented using one or more computers 200. The web server may host the entire auction system 310 or may rely on additional back end servers. For example, the daemon service 340 may run on a separate server. The web server 320 interacts with a persistent storage system, e.g., a database 330. The storage may be internal or external to the web server 320. For example, the web server 320 may access the database 330 via a network 110.

The database 330 maintains data related to the auctions and to the users of the auction system 310. For example, for any one auction, the database may record one or more of an auction identifier, a bid value for the highest bid, a bidder identifier for the highest bid, a time stamp for the current highest bid, a time stamp for the current time, a time stamp for a previous bid, a vector of bid values, a vector of bidder identifiers, a vector of bid times. The database may be a relational database. The database may use cloud-based storage. The database may use a data warehouse.

The daemon service 340 monitors the status of bids within the auction system 310. For example, in some embodiments, the daemon service 340 calculates the difference between a time stamp for a current bid placed and a time stamp for a previous bid placed. The daemon service 340 may be running on the web server 320, on the database 330, or on another server. The daemon service 340 may access the database 330 directly or the daemon service 340 may rely on a persistence layer between the daemon service 340 and the database 330. For example, in some embodiments, the daemon service 340 only communicates with the web server 320 and relies on the web server 320 to provide needed data. In some embodiments, the daemon service 340 periodically checks the bidder id for the highest bid on each active auction. The daemon service 340 can then track a time period for which a user is the highest bidder in an active auction. In some embodiments, the period is twice per second. The web server 320 may access the daemon service 340 to determine the time period for a highest bid in an active auction and provide that information to a user, e.g., via the client browser 370.

The client browser 370 runs on a user device 170. For example, a web browser running on a laptop 370b or mobile device 370c may function as a client browser 370. In some embodiments, a user interacts with the auction system 310 using the client browsers 370. The user may be able to see active and recently closed auctions, account status information, and bids placed, using the client browser 370.

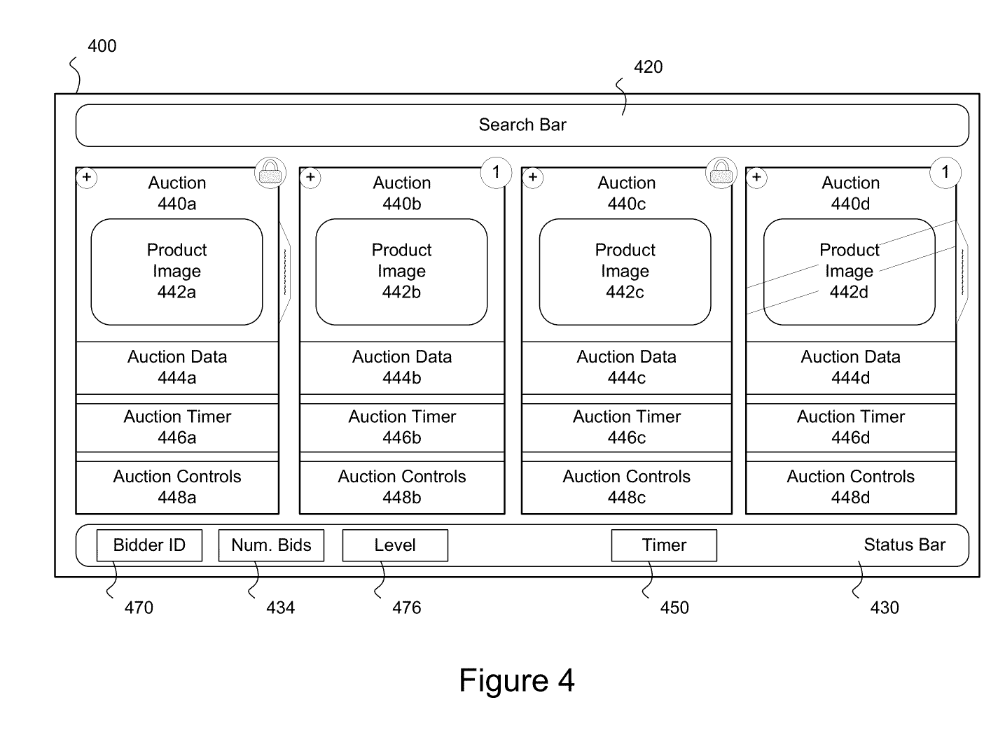

FIG. 4 illustrates an example user interface 400 as may be seen in a client browser 370 on a user device 170. The illustrated example interface 400 includes a search bar 420, a status bar 430, and multiple auctions 440a-n. Each of the auctions 440a-n is represented with a product image 442a-n, auction data 444a-n, an auction timer 446a-n, and auction controls 448a-n. The status bar includes a timer 450, a bidder identifier 470 for the user, a level 476 for the bidder identifier 470, and a number of bids 434 for the bidder identifier 470.

The interface 400 is, in some embodiments, a web page with a number of elements. The elements may be updated without refreshing the web page, using, for example, AJAX, Javascript, or Flash. Each of the auctions 440a-n may be updated independently of the other auctions. For example, a first auction 440a may be updated independently of the remaining auctions 440b-n. While the elements of the interface 400 are illustrated in one configuration, the elements may be presented in other configurations. In some embodiments, different elements are presented. The illustration of FIG. 4 is provided as an example of an interface and is not meant to be limiting.

The search bar 420 provides a user with the ability to search the active and recently closed auctions. The user may enter search terms into the search bar and cause the display to show relevant auctions. In some embodiments, the search bar may be used to find information about the auction sellers and bidders. In some embodiments, the search bar may be used to find information about the incentives and awards.

The status bar 430 provides the user with information about the user's bidding account. In some embodiments, a user of the auction system registers a bidding account with a bidder identifier 470. The status bar 430 displays the user's bidder identifier 470 and information about the bidding account including, for example, a level 476 and a number of bids 434. The status bar 430 also displays one or more timers 450.

The number of bids 434 indicates to the user how many bids placed using the bidding account are currently active. In some embodiments, a bid must be the highest bid in the particular auction bid upon in order to be considered active.

The bidding identifier 470 is illustrated as displayed in the status bar 430. It is not necessary to display the bidding identifier 470. In some embodiments, the auction system allows guest visitors or for a user to have multiple accounts. Displaying the bidding identifier 470 informs the user that they are logged in under an account by this name.

The level indicator 476 is illustrated as displayed in the status bar 430. It is not necessary to display the level indicator 476. In some embodiments, there are no levels. In some embodiments, a user is rewarded by an increase in level. For example, a user may accrue points for winning auctions or for having the highest bid in an auction for a period of time. A sufficient number of points may result in a level increase. A bidding account with a higher level may have access to additional features. For example, the account may be allowed access to restricted auctions, may be allowed early access to auctions, may be allowed to use bidding tools, may receive discounts, or may receive other perks. In some embodiments, a bidding account must achieve a certain level before being able to create new auctions.

The timer 450 indicates a period of time for which the bidding account is the highest bidder. In some embodiments, the timer 450 is cumulative for the life of the bidding account. In some embodiments, the timer 450 is cumulative for all active auctions for which the bidder is the highest bidder. That is, if the bidder has been the highest bidder in a first auction for the last 3 minutes, and the highest bidder in a second auction for the last 2 minutes, the timer 450 indicates that the bidder has been the highest bidder for 5 minutes.

Each of the auctions 440a-n is represented with a product image 442a-n, auction data 444a-n, an auction timer 446a-n, and auction controls 448a-n. Each auction 440 is has a creator, a minimum bid, and an end time. Generally, the end time is established by the auction creator. In some embodiments, the end time increases with bid activity. For example, each bid adds a number of seconds to the end time. The number of seconds may vary based on an anticipated value for the offer or based on the actual length of time the auction has been active. In some embodiments, the number of seconds added for each additional bid is displayed next to the auction timers 446a-n.

The product images 442a-n are generally descriptions, pictures, logos, or trademarks associated with the auction offer. The product images 442a-n inform the bidder as to the auction offer. In some embodiments, a banner may be placed across the image, as illustrated with product image 442d, to demonstrate a restriction. The auction may be closed, the auction may be active but restricted to bidders above a certain level, or the auction may be active but restricted to bidders already participating in the auction. Restrictions on an auction may be indicated by icons anywhere on, in, or near the auction 440a-n. Restrictions may be indicated, for example, with an image of a padlock or by text in an adjacent tab. The product images 442a-n may be provided by third parties.

The auction data 444a-n specifies the current highest bid and the bidder account name for the highest bid. In some embodiments, the auction data 444a-n includes a retail price for the offer. A bidder can purchase the offer for the retail price without having to win the auction. In some embodiments, the auction data 444a-n indicates how long the highest bidder has been the highest bidder.

The auction timers 446a-n indicate the time remaining until the end time for each auction. In some embodiments, a second timer next to the time-remaining timer indicates an amount of time that will be added to the time remaining for each bid. When the time-remaining timer reaches zero, the auction ends. This is a terminating event for the auction. In some embodiments, an auction may also be terminated by an administrator for the auction website, e.g., to prevent fraud, or by the seller, e.g., because the offer is no longer available.

The auction controls 448a-n provide an interface for the user to place bids. In some embodiments, each bidding event increases the auction price by a penny (“Penny Auction”) and the bidder pays a separate fee for each bid. In some embodiments, the user enters a bid amount. In some embodiments, the user is presented with an immediate purchase opportunity. The user may elect to pay a retail price for the offer. The opportunity may persist even after the auction has ended, if, for example, the auction was for multiple instances of the offer.

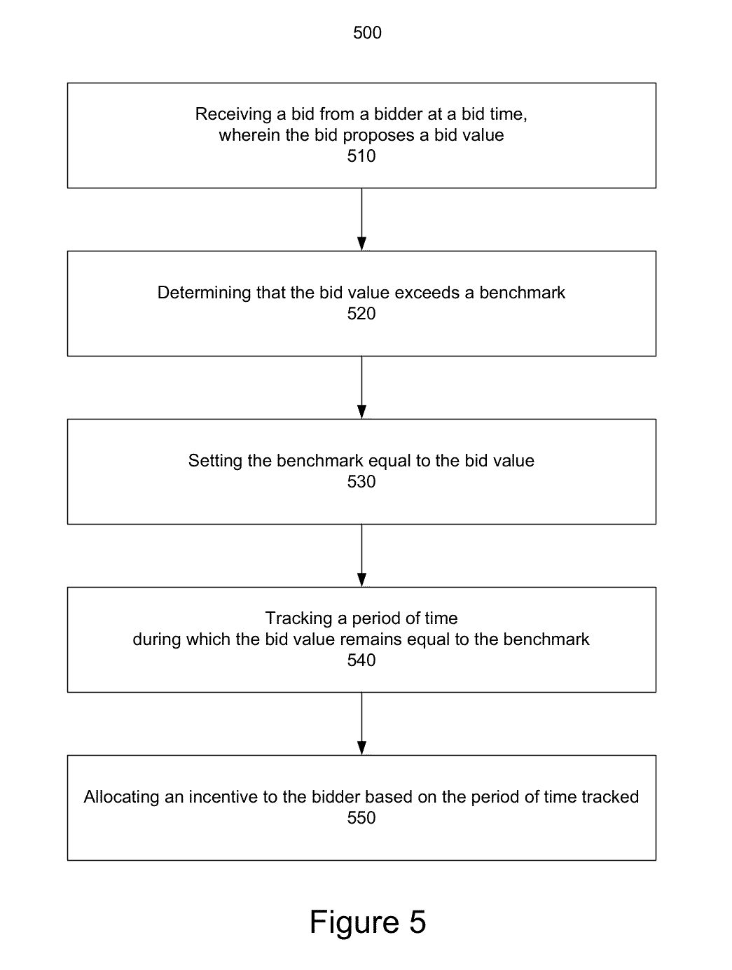

Referring to FIG. 5, a flowchart 500 illustrates a method for allocating an incentive to a bidder based on time as the highest bidder. Generally, at step 510, an auction server 150 receives a bid from a bidder at a bid time, wherein the bid proposes a bid value. At step 520, the auction server 150 determines that the bid value exceeds a benchmark. At step 530, the auction server 150 sets the benchmark equal to the bid value. At step 540, the auction server 150 tracks a period of time during which the bid value remains equal to the benchmark. At step 550, the auction server 150 allocates an incentive to the bidder based on the period of time tracked in step 540.

At step 510, an auction server 150 receives a bid from a bidder at a bid time, wherein the bid proposes a bid value. The bid value may be an incremental increase over a previous bid value. For example, in a penny auction system, each bid is a penny—but the bid value is the sum of the previous bids plus the additional penny for the new bid. That is, the bid value is the total bid proposed by the bidder. In some embodiments, the auction server 150 records the bid, an identifier for the bidder, the bid value, a timestamp for the bid time, and any other relevant data, in a database, e.g., the database 330 illustrated in FIG. 3. In some embodiments, the bid is added to a log or vector of bids stored for the auction. In some embodiments, only a bid establishing a new benchmark is recorded. Responsive to receiving the bid, the auction server 150 may provide confirmation to the bidder that the bid was received. For example, the auction display may update to reflect the new bid.

At step 520, the auction server 150 determines that the bid value exceeds a benchmark. Generally, only a bid with a bid value exceeding the benchmark would be considered a relevant bid. In most auctions, the winner is the highest bid. The benchmark then is the highest bid received so far. At the beginning of the auction, the benchmark may be zero or some reserve price that must be met. In some auctions, the winner is the lowest bid. The benchmark then is the lowest bid received so far. At the beginning of the auction, the benchmark may be an initial bid or a value representing infinity. The superlative bid is the best bid.

At step 530, the auction server 150 sets the benchmark equal to the bid value. Each new bid is expected to exceed the previous benchmark. This may be tracked by setting the benchmark value to the new bid value. In some embodiments, a pointer to the best bid is set, instead of maintaining the value separately. In some embodiments, only the best bid is recorded and setting the benchmark is a matter of updating the bid record for the best bid.

At step 540, the auction server 150 tracks a period of time during which the bid value remains equal to the benchmark. Time may be tracked by periodically polling the auction to determine the best bid. Time may be tracked by computing the delta between an end time, e.g., the present time, and the bid time. In an embodiment providing an estimate to the bidder while the auction is live, the auction server 150 may periodically poll the auction and update the display. Such an embodiment may verify the estimate when the auction terminates and there is a fixed end time to compare to the start time. In general, multiple bidders will take turns having the best bid. The auction server 150 tracks each turn and accumulates a total best bid time for each bidder. The sum of the total best bid times should equal the total time of the auction, although rounding errors may cause it to be higher.

At step 550, the auction server 150 allocates an incentive to the bidder based on the period of time tracked in step 540. Each bidder receives an incentive based on the time for which that bidder had the best bid in the auction. The time may be divided into units. For example, the incentive may be based on the number of half-seconds in which the bidder had the best bid. In some embodiments, the incentive allocated is a point for each half-second. The points may be redeemable for one or more of a prize, a financial amount, a level increase, virtual credits, discounts, upgrades, additional bid opportunities, access to restricted auctions, VIP access, travel rewards, goods, and services.

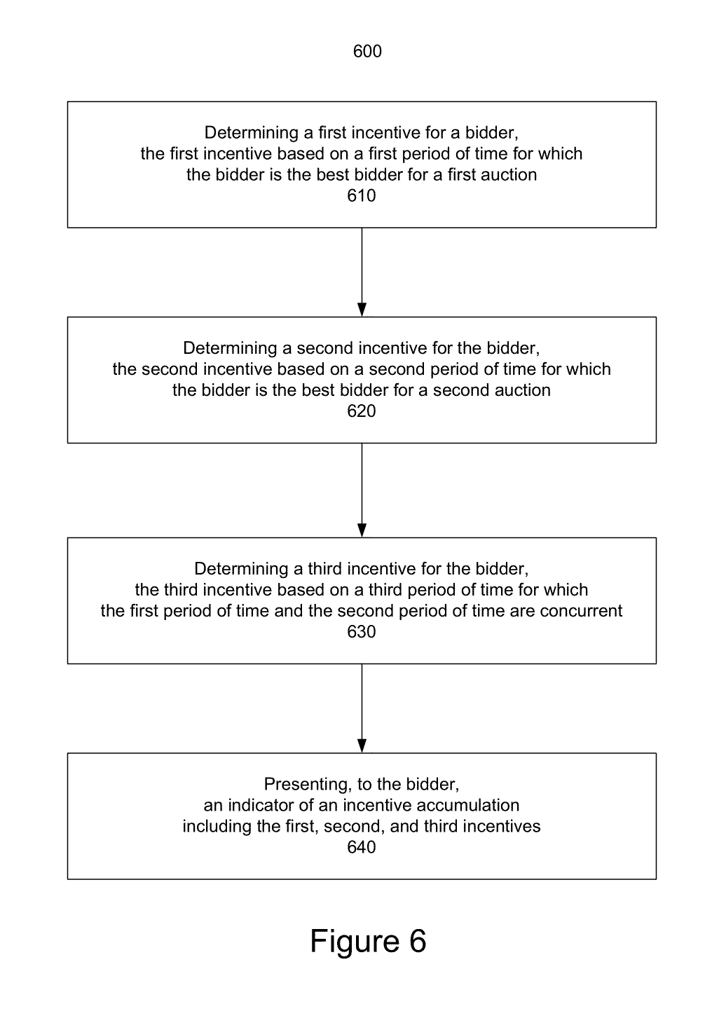

Referring to FIG. 6, a flowchart 600 illustrates a method for providing a bidder a bonus incentive for being the highest bidder in multiple auctions concurrently. Generally, at step 610, an auction server 150 determines a first incentive for a bidder, the first incentive based on a first period of time for which the bidder is the best bidder for a first auction. At step 620, the auction server 150 determines a second incentive for the bidder, the second incentive based on a second period of time for which the bidder is the best bidder for a second auction. At step 630, the auction server 150 determines a third incentive for the bidder, the third incentive based on a third period of time for which the first period of time and the second period of time are concurrent. At step 640, the auction server 150 presents, to the bidder, an indicator of an incentive accumulation including the first, second, and third incentives.

At step 610, the auction server 150 determines a first incentive for a bidder, the first incentive based on a first period of time for which the bidder is the best bidder for a first auction. For example, the auction server 150 may use the method 500 illustrated in FIG. 5. The bidder is the best bidder when the bids placed by the bidder exceed the benchmark. Usually, this means the bids placed are the highest bids. In some embodiments, a bidder may use a tool place multiple bids to ensure that the bidder remains the highest bidder. The time for such a tool may be negligible and the minimal time other bidders may force the tool to place additional bids does not necessarily detract from the time during which the bidder is considered the best bidder.

At step 620, the auction server 150 determines a second incentive for the bidder, the second incentive based on a second period of time for which the bidder is the best bidder for a second auction. As in step 630, the auction server 150 may use the method 500 illustrated in FIG. 5. The first period of time and the second period of time are tracked independently, each corresponding to the respective auction. The bidder receives an incentive for each auction regardless of if the auctions overlap.

At step 630, the auction server 150 determines a third incentive for the bidder, the third incentive based on a third period of time for which the first period of time and the second period of time are concurrent. The third incentive is a bonus incentive. In some embodiments, there is no bonus and the third incentive is zero. In some embodiments, the third incentive is a multiplier to the first or second incentive. In some embodiments, the first period of time and the second period of time are considered concurrent if the first auction and the second auction are active contemporaneously. In some embodiments, the first period of time and the second period of time are considered concurrent if the earliest start time for the first period of time falls between the earliest start time of the second period of time and the last end time of the second period time, or vice-versa.

At step 640, the auction server 150 presents, to the bidder, an indicator of an incentive accumulation including the first, second, and third incentives. For example, in the display illustrated in FIG. 4a, the auction server 150 may update the status bar 430 to show the accumulation of incentives.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer-readable storage media for execution by, or to control the operation of, data processing apparatus. The program instructions can be encoded on an artificially generated propagated signal, e.g., a machine-generated electrical, optical, or electromagnetic signal that is generated to encode information for transmission to suitable receiver apparatus for execution by a data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially generated propagated signal. The computer-readable storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The auction server 150 or auction system 310 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a LCD (liquid crystal display) monitor, LED or OLED screen, a CRT (cathode ray tube), a plasma screen, or a projector, for displaying information to the user and a touch screen, keyboard, or a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an embodiment of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 310 can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific embodiment details, these should not be construed as limitations on the scope of any inventions or of what may be claimed, but rather as descriptions of features specific to particular embodiments of particular inventions. Certain features described in this specification in the context of separate embodiments can also be implemented in combination in a single embodiment. Conversely, various features described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements. References to “or” may be construed as inclusive so that any terms described using “or” may indicate any of a single, more than one, and all of the described terms.

Thus, particular embodiments of the subject matter have been described. Other embodiments are within the scope of the following claims.

What is claimed is:

1) A method of hosting an auction, the method comprising:
receiving a first bid from a first bidder at a first time, wherein the bid proposes a first value;
determining that the first value exceeds a benchmark;
setting the benchmark equal to the first value;
tracking a first period of time during which the first value remains equal to the benchmark; and
allotting based on the first period of time, an incentive to the first bidder.

2) The method of claim 1, further comprising:
terminating the auction while the first value equals the benchmark;
ending the first period of time; and
charging the first bidder the first value.

3) The method of claim 1, further comprising:
receiving a second bid from a second bidder at a second time, wherein the second time is subsequent to the first time and the second bid proposes a second value exceeding the benchmark value;
ending the first period of time;
setting the benchmark equal to the second value;
tracking a second period of time during which the second value remains equal to the benchmark; and
allotting, based on the second period of time, an incentive to the second bidder.

4) The method of claim 1, further comprising:
receiving a second bid from a second bidder at a second time, wherein the second time is subsequent to the first time and the second bid proposes a second value exceeding the benchmark value;
responsive to receiving the second bid, ending the first period of time and setting the benchmark equal to the second value;
receiving a third bid from the first bidder at a third time, wherein the third time is subsequent to the second time and the third bid proposes a third value exceeding the benchmark equal to the second time;
responsive to receiving the third bid, ending the second period of time and setting the benchmark equal to the third value; and
allotting, based on the third period of time, an incentive to the first bidder in addition to the incentive allocated based on the first period of time.

5) The method of claim 1, wherein the first value is a previous bid value plus an incremental value over the previous bid value.

6) The method of claim 1, wherein allotting the incentive is based on a quantity of time units in the first period of time wherein the first value is equal to the benchmark.

7) The method of claim 5, wherein the incentive is a point for each time units in the quantity and one or more point are redeemable for one or more of a prize, a financial amount, a level increase, virtual credits, discounts, upgrades, additional bid opportunities, access to restricted auctions, VIP access, travel rewards, goods, and services.

8) The method of claim 1, wherein the benchmark is a value higher than any other bid value in the auction.

9) The method of claim 1, wherein tracking the first period of time comprises periodically checking the benchmark.

10) The method of claim 1, wherein tracking the first period of time comprises computing an elapsed time from the first time to either of a time associated with a subsequent bid having a bid value higher than the first value and an auction terminating event.

11) A system for hosting an auction, the system comprising:
an auction server comprising at least one physical processor, the auction server configured to:
receive a first bid from a first bidder at a first time, wherein the bid proposes a first value;
determine that the first value exceeds a benchmark;
set the benchmark equal to the first value;
track a first period of time during which the first value remains equal to the benchmark; and
allot, based on the first period of time, an incentive to the first bidder.

12) The system of claim 11, the auction server further configured to:
terminate the auction, wherein the first value equals the benchmark when the auction is terminated;
end the first period of time; and
charge the first bidder the first value.

13) The system of claim 11, the auction server further configured to:
receive a second bid from a second bidder at a second time, wherein the second time is subsequent to the first time and the second bid proposes a second value exceeding the benchmark value;
end the first period of time;
set the benchmark equal to the second value;
track a second period of time during which the second value remains equal to the benchmark; and
allot, based on the second period of time, an incentive to the second bidder.

14) The system of claim 11, the auction server further configured to:
receive a second bid from a second bidder at a second time, wherein the second time is subsequent to the first time and the second bid proposes a second value exceeding the benchmark value;
responsive to receiving the second bid, end the first period of time and set the benchmark equal to the second value;
receive a third bid from the first bidder at a third time, wherein the third time is subsequent to the second time and the third bid proposes a third value exceeding the benchmark equal to the second time;
responsive to receiving the third bid, end the second period of time and set the benchmark equal to the third value; and
allot, based on the third period of time, an incentive to the first bidder in addition to the incentive allocated based on the first period of time.

15) The system of claim 11, wherein allotting the incentive is based on a quantity of time units in the first period of time wherein the first value is equal to the benchmark.

16) The system of claim 15, wherein the incentive is a point for each time units in the quantity and one or more point are redeemable for one or more of a prize, a financial amount, a level increase, virtual credits, discounts, upgrades, additional bid opportunities, access to restricted auctions, VIP access, travel rewards, goods, and services.

17) The system of claim 11, wherein the auction server is configured to track the first period of time by periodically checking the benchmark.

18) The system of claim 11, wherein the auction server is configured to track the first period of time by computing an elapsed time from the first time to either of a time associated with a subsequent bid having a bid value higher than the first value and an auction terminating event.

19) A method of incentivizing bidding at an online auction website, where each auction having at least one bidder has a highest bidder, the method comprising:
awarding a first incentive to a first bidder in a first auction, the incentive based on a first period of time for which the first bidder is the highest bidder for the first auction;
awarding a second incentive to the first bidder in a second auction, the incentive based on a second period of time for which the first bidder is the highest bidder for the second auction; and
awarding a third incentive to the first bidder based on a third period of time for which the first period of time and on the second period of time are concurrent.

20) The method of claim 19, further comprising:
accumulating an incentive balance for the first bidder, adding the first incentive, the second incentive, and the third incentive to the incentive balance; and
displaying, via the auction website, an indicator of the incentive balance during either or both of the first period of time and the second period of time.
